(19) United States
(12) Patent Application Publication
(10) Pub. No.: US 2026/0153999 A1
(43) Pub. Date: Jun. 4, 2026

(54) PASS THROUGH VOLTAGE ADJUSTMENT TO COMPENSATE FOR CROSS-TEMPERATURE EFFECTS

(71) Applicant: Microchip Technology Incorporated, Chandler, AZ (US)

(72) Inventors: Salvatrice Scommegna, Cornate D'Adda (IT); Pitamber Shukla, San Jose, CA (US); Michele Cirella, Castelmassa (IT); Antonio Aldarese, Vimercate (IT)

(73) Assignee: Microchip Technology Incorporated, Chandler, AZ (US)

(21) Appl. No.: 19/224,033

(22) Filed: May 30, 2025

Related U.S. Application Data
(60) Provisional application No. 63/728,048, filed on Dec. 4, 2024.

(51) Int. Cl. G06F 3/06

(52) U.S. Cl. CPC G06F 3/0619; G06F 3/0655; G06F 3/0679

(57) ABSTRACT

A data storage system includes a memory device (e.g., a solid state drive), a memory (e.g., a random access memory) including instructions stored thereon, and at least one processor. The memory device includes a block and a plurality of wordlines (WLs). The memory includes instructions stored thereon that, when executed by the at least one processor, cause the at least one processor to: detect errors associated with the block; determine, based at least in part on the detected errors, a cross-temperature condition; adjust a pass through voltage (Vpassr) based on the determined cross-temperature condition; and perform a read operation at least in part by: applying a read voltage to a first WL of the plurality of WLs; and applying the adjusted Vpassr to one or more remaining WLs of the plurality of WLs.

### CROSS-REFERENCE TO RELATED APPLICATIONS

The current patent application claims the benefit under 35 U.S.C. § 119(e) of the priority date of U.S. Provisional Application Ser. No. 63/728,048; titled “FIRMWARE DRIVEN VPASSR VOLTAGE ADJUSTMENT TO COMPENSATE FOR CROSS-TEMPERATURE EFFECT TO IMPROVE DRIVE PERFORMANCE”; and filed Dec. 4, 2024. The Provisional Application is hereby incorporated by reference, in its entirety, into the current patent application.

### TECHNICAL FIELD

Various examples of the present disclosure relate to systems and methods for adjusting a pass through voltage (Vpassr) to compensate for cross temperature effects.

### BACKGROUND

Cross-temperature conditions in memory devices can occur when an operating temperature associated with programming data is different than an operating temperature associated with reading data. Read voltage thresholds of cells in the memory device may be different under different temperature conditions. Cross-temperature conditions may cause an increase in errors produced during read operations, due to the changing read voltage thresholds.

This background discussion is intended to provide information related to the present invention which is not necessarily prior art.

### SUMMARY OF THE INVENTION

According to various examples of the present disclosure, a data storage system includes a memory device, a memory including instructions stored thereon, and at least one processor. The memory device includes a block and a plurality of wordlines (WLs). The memory includes instructions stored thereon that, when executed by the at least one processor, cause the at least one processor to: detect errors associated with the block; determine, based at least in part on the detected errors, a cross-temperature condition; adjust a pass through voltage (Vpassr) based on the determined cross-temperature condition; and perform a read operation at least in part by: applying a read voltage to a first WL of the plurality of WLs; and applying the adjusted Vpassr to one or more remaining WLs of the plurality of WLs.

According to various examples of the present disclosure, a computer-implemented method includes: detecting errors associated with a block; determining, based at least in part on the detected errors, a cross-temperature condition; adjusting a pass through voltage (Vpassr) based on the determined cross-temperature condition; and performing a read operation at least in part by: applying a read voltage to a first wordline (WL) of a plurality of WLs of the block; and applying the adjusted Vpassr to one or more remaining WLs of the plurality of WLs.

According to various examples of the present disclosure, non-transitory computer readable media having instructions stored thereon are provided. When executed by at least one processor, the instructions cause the at least one processor to: detect errors associated with a block; determine, based at least in part on the detected errors, a cross-temperature condition; adjust a pass through voltage (Vpassr) based on the determined cross-temperature condition; and perform a read operation at least in part by: applying a read voltage to a first wordline (WL) of a plurality of WLs of the block; and applying the adjusted Vpassr to one or more remaining WLs of the plurality of WLs.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example system for adjusting Vpassr to compensate for cross temperature effects;

FIG. 2 illustrates an example computing system configured to perform operations in accordance with the various examples of the present disclosure;

FIG. 3A illustrates an example non-volatile memory (NVM) media of the system of FIG. 1;

FIG. 3B includes a table illustrating a logical layout of at least a portion of an NVM media of the memory device of FIG. 1;

FIG. 3C is a block diagram of additional hierarchy of at least a portion of an NVM media of the memory device of FIG. 1;

FIG. 4 illustrates an example physical memory block of the NVM media of FIG. 3A;

FIG. 5A illustrates a graph of voltage thresholds corresponding to various programming states of a triple level cell (TLC) wordline when a program temperature is greater than a read temperature;

FIG. 5B illustrates a graph of voltage thresholds corresponding to various programming states of a TLC wordline when a read temperature is greater than a program temperature;

FIG. 6 illustrates an example method for adjusting Vpassr to compensate for cross temperature effects; and

FIG. 7 illustrates an example method for detecting a cross-temperature condition.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

The term “signal” or “electronic signal” may be used to describe an electromagnetic wave conducted through an electrically conductive medium in which an electric voltage and/or an electric current varies, or may be constant, over time.

The term “electrically connected” may refer to components comprising conductor(s) such as terminals or contacts, with the conductor(s) of the respective electrically connected components being in electrical communication with one another via a pathway, the pathway typically comprising one or more conductor(s) such as metal(s) or metal alloy(s), optionally being interspersed with electronic component(s), and allowing the electrical communication via flow of electric current therebetween.

Various examples of the present disclosure may be used in single-level cell (SLC) systems, multi-level cell (MLC) systems, triple-level cell (TLC) systems, quad-level cell (QLC) systems, and penta-level cell (PLC) systems, without limitation. Applications may include consumer hard drives, high performance computing (HPC), data transfer for AI, and data center solutions (DCS), without limitation.

In various examples of the present disclosure, a data storage system may include a memory device and a controller. The memory device may store data. The data storage system may be connected to a host system. The controller may be operable to manage storage and retrieval of data between the memory device and the host system.

The host system may send a read request to the data storage system. The read request may indicate data to be retrieved from the memory device and sent back to the host system. The controller may process the read request, retrieve the data from the memory device, process the retrieved data, and send the retrieved data to the host system. The data may be read from the memory device using a threshold voltage.

Voltage thresholds of the cells may shift over time due to cross-temperature effects. As used herein, cross-temperature may correspond to a difference between a write temperature (e.g., an operating temperature of the memory device when data is written to cells of the memory device) and a read temperature (e.g., an operating temperature of the memory device when data is read from the cells of the memory device).

In various examples of the present disclosure, the controller may detect an increase in a number of errors produced by one or more blocks of the memory device. The controller may determine whether the increased number of errors is caused by a cross-temperature condition. A cross-temperature condition may refer to a mismatch between a program temperature at which data was programmed to the block(s) and a read temperature at which data is read from the block(s). Responsive to detecting the increased number of errors, the controller may read a current temperature of the memory device. If the current temperature of the memory device is significantly different (e.g., a difference of at least ten (10), fifteen (15), twenty (20), or more ° C.) than a normal operating temperature range of the memory device (e.g., between twenty (20) and fifty (50) ° C., without limitation), the controller may determine cross-temperature conditions may be causing the increased number of errors. In various examples, the controller may infer a cross temperature condition based on the detected errors and an estimated read threshold voltage shift. For example, such an inference may be based on patterns which have been correlated with cross temperature conditions, such as where a given error profile or collection of error profiles for one or more block(s), whether taken at a moment in time or across time, is correlated through machine learning processes with cross temperature conditions with a sufficiently high degree of confidence. Accordingly, the controller may adjust a pass through voltage (Vpassr) applied to one or more wordlines during one or more read operations to compensate for the determined cross-temperature condition.

Broadly, Vpassr is a voltage that passes directly through a circuit, from input to output, as if there were zero (0) impedance in the circuit (e.g., as if a wire were shorting the input to the output). In NAND flash, Vpassr may be applied to unselected wordlines (WLs) of a block of a NAND flash device during a read operation. Application of the pass-through voltage may ensure the unselected WLs are “ON,” or working/operating at the value of the applied Vpassr. This may enable data from one or more cells of a selected WL (e.g., the WL of the block being read that is receiving a read voltage, Vread) to be transmitted via bitlines (BLs) of the block being read. Vpassr is typically greater than Vread. Vpassr is also typically greater than the highest threshold voltage corresponding to a programmed state (e.g., greater than the highest threshold voltage corresponding to binary ‘101’ in a TLC).

Accordingly, the adjustment of Vpassr to compensate for cross-temperature conditions may reduce an amount of time used to read data from the memory device compared to alternative approaches which may employ a background read positioning (BRP) algorithm or a read retry (RR) algorithm in response to detecting an increased number of errors. The BRP and RR algorithms require a large number of read operations, consuming significant resources (e.g., power and time).

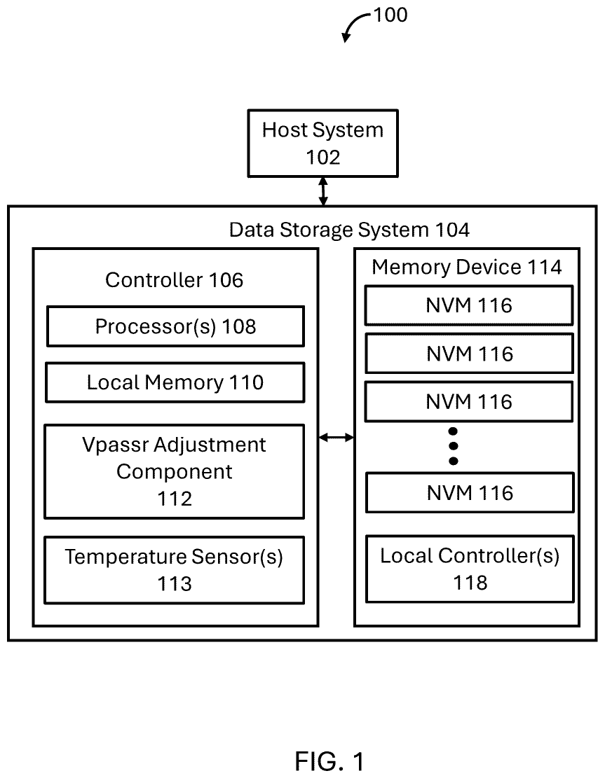

FIG. 1 illustrates an example system 100 including a host system 102 and a data storage system 104. The data storage system 104 includes include a controller 106 and a memory device 114. The controller 106 includes a processor 108, a local memory 110, a Vpassr adjustment component 112, and one or more temperature sensors 113. The memory device 114 includes a plurality of non-volatile memory (NVM) media 116 and one or more local controller(s) 118. In various examples, the local controller(s) 118 may include one or more temperature sensors for measuring a temperature of the memory device 114 and/or one or more of the NVM 116.

In various examples, a read or write request may be received from the host system 102 via a peripheral component interconnect express (PCIe) interface that connects the data storage system 104 to servers or CPUs. PCIe is a standardized interface for motherboard components. In various examples, the data storage system 104 may be connected to the host system 102 by wired or wireless means (e.g., through a communications network). The data storage system may be connected to more than one host system, such as in a multi-tenant environment, without limitation.

The controller 106 may use logical block addresses (LBAs) and physical block addresses (PBAs) to facilitate access for data storage in and retrieval from the NVM media 116. LBAs are an abstraction to allow the operating system to interact with the NVM media 116, and PBAs represent the actual hardware locations within the NVM media 116. To facilitate interacting with the NVM media 116, the controller 106 may create an entry or record that assigns an LBA to a PBA. To keep track of all such LBA-to-PBA assignments, the controller 106 may use a logical-to-physical (L2P) mapping table. The L2P table may be uploaded to the local memory 110 so that it can be more quickly accessed and updated by the controller 106. In various examples, the local memory 110 may include a synchronous dynamic random access memory (SDRAM), without limitation.

When a data request is received from the host system 102, the controller 106 references the L2P mapping table to determine the PBA within the NVM media 116 corresponding to a desired LBA. Once the PBA is determined, the controller 106 accesses the appropriate NVM media 116 to write or read the data. Access to the NVM media 116 may be via a flash physical (PHY) interface. The controller 106 may employ an error correction code (ECC) operation during encoding and decoding data to detect and correct errors and enhance data integrity. Additionally, the memory device 114 may support a direct memory access (DMA) operation enabling data to be written from the host system 102 directly to the NVM media 116 and read from the NVM media 116 directly to the host system 102. Certain commands may be issued to the controller 106 or the local controller(s) 118 using the host command layer, or non-volatile memory express management interface (NVMe-MI).

In various examples, the data storage system 104 may be a solid state drive (SSD), and the NVM media 116 may be NAND-based flash memory. It would be appreciated by one of ordinary skill in the art that other memory devices (e.g., NOR flash memory, random access memory, and the like) may be utilized in the various examples described herein without departing from the spirit of the present disclosure.

In various examples, the controller 106 may receive a write request from the host system 102. The write request may include user data to be written to one or more of the NVM media 116 of the memory device 114. The user data may include, for example, media (e.g., photos, videos, and/or audio), system information data, application data, sensor data, document data, recordkeeping data, machine learning/artificial intelligence data, gaming system data, data pertaining to internal operations of the host system, and the like, without limitation.

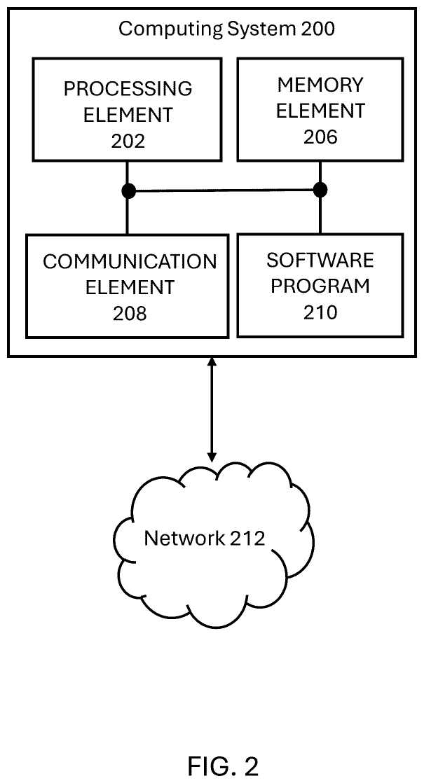

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1), a data storage system (e.g., the data storage system 104 of FIG. 1), and/or another computing device configured to perform some and/or all operations of the various examples of the present disclosure, without limitation.

The software program 210 may be configured with instructions for performing and/or enabling performance of at least some of the steps set forth herein. In an example, the software program 210 comprises instructions stored on computer-readable media of memory element 206. In various examples, the software program 210 may include instructions for performing operations of the Vpassr adjustment component 112 discussed with reference to FIG. 1.

The communication network 212 generally allows communication between the computing system 200 and another computing device, such as between a remote host system (e.g., the host system 102), a local host system, and/or a data storage system (e.g., the data storage system 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain examples, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some examples, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In various examples, the memory element 206 stores the software applications/program 210. The memory element 206 may also store settings, data, documents, sound files, photographs, movies, images, databases, and the like. In various examples, the memory element 206 may include a first memory component (e.g., the local memory 110 of FIG. 1) and one or more SSDs (e.g., the memory device 114 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

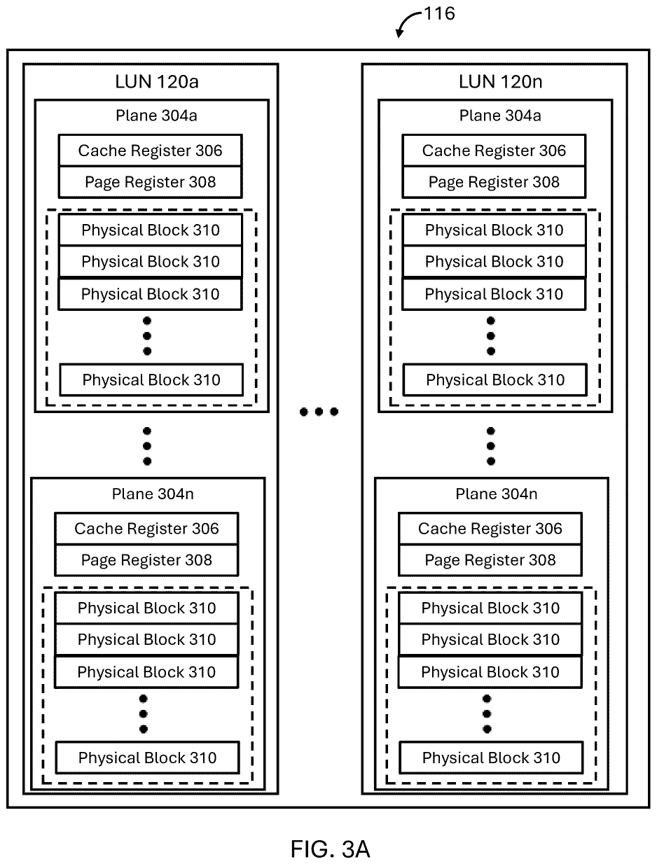

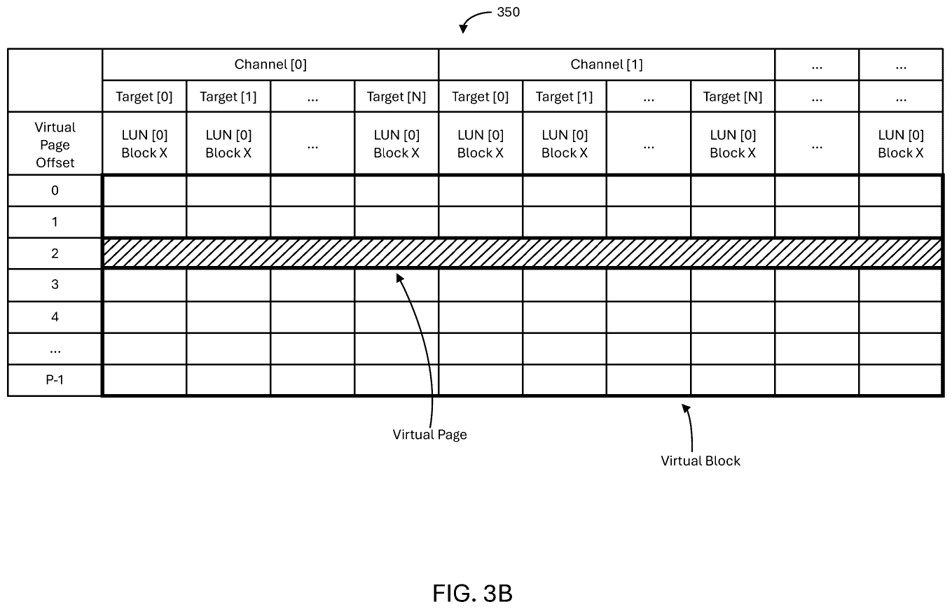

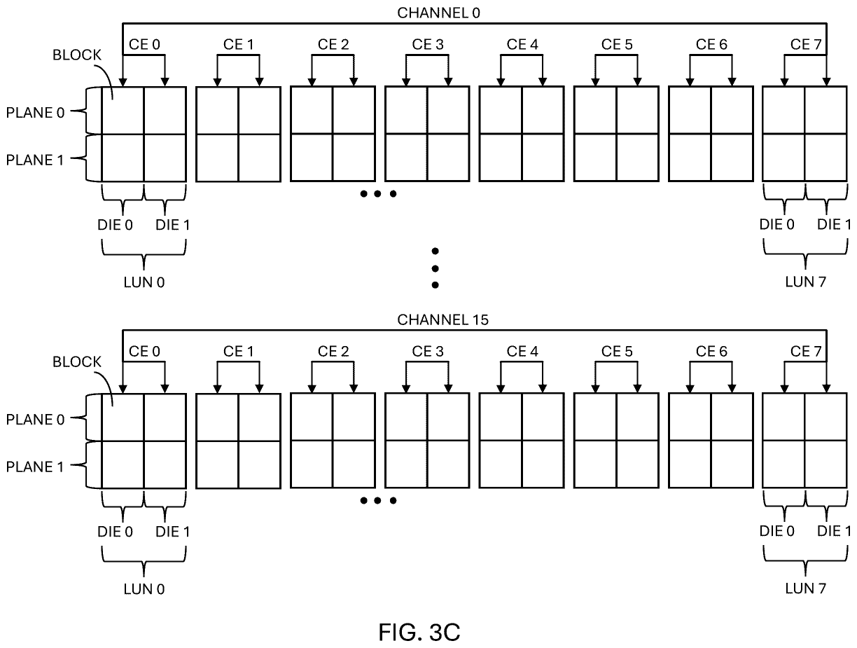

With reference to FIGS. 3A-3C, an example of the memory device 114 includes a plurality of channels, CHANNEL 0 through CHANNEL 15. Each channel includes a plurality of logical units, LUN 0 through LUN 7, with each LUN being a chip package that includes a plurality of dies, DIE 0 and DIE 1. Each die includes a plurality of planes, PLANE 0 and PLANE 1. It is noted that in other examples, each die includes more than two (2) planes and may include up to six (6) planes or more. Each plane includes at least one block of data storage.

Referring to FIG. 3A, the NVM media 116 may respectively include a plurality of dies. In various examples, the NVM media 116 may respectively include two (2), four (4), eight (8), sixteen (16), twenty four (24), thirty two (32), or more dies, without limitation. One or more dies of each NVM 116 may correspond to a logical unit (LUN). Each NVM 116 may include LUNs 120a, . . . 120n. Each LUN 120a, . . . 120n may include a plurality of planes 304a, . . . 304n. Each LUN 120a, . . . 120n may include, for example, four (4), six (6), eight (8), or more planes, without limitation.

Each plane 304a, . . . 304n may include a cache register 306, a page register 308, and a plurality of physical memory blocks 310. In various examples, the controller 106 may write incoming data to more than one NVM media 116 in parallel. The NVM media 116 may write incoming data to more than one LUN in parallel.

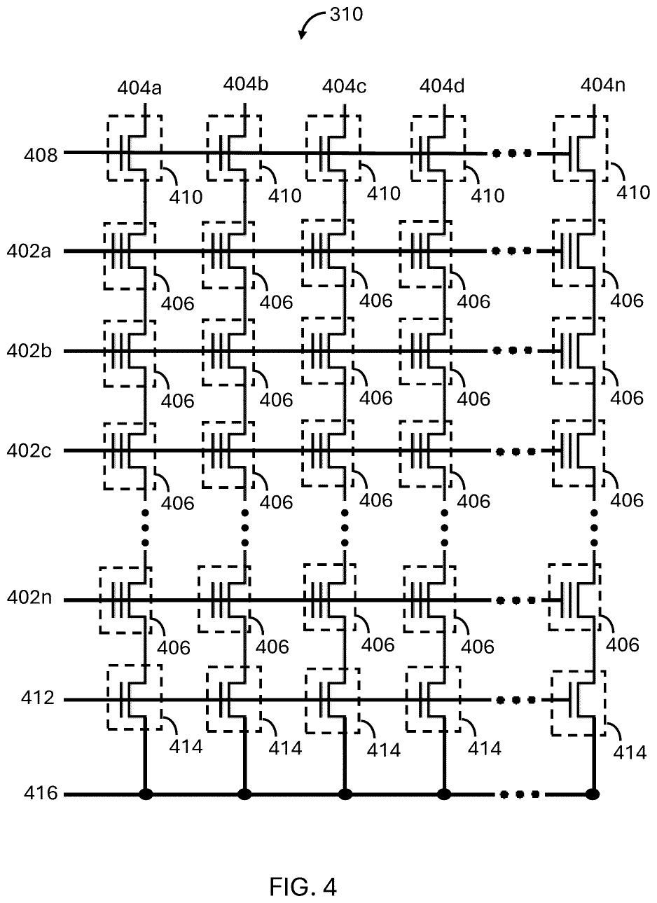

When data is written to or retrieved from the NVM media 116, the data may be temporarily stored in one of the cache register 306 and the page register 308. Each physical memory block 310 may include a set of pages (as described in connection with FIG. 4 below). The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

In various examples, the physical blocks 310 may be organized into virtual blocks (VBs). A VB may include one physical block from each plane of each LUN of each NVM 116 of the memory device 114. Each VB may include a set of virtual wordlines (VWL). Each VWL may include a set of WLs (e.g., a VWL may include one (1) WL from each physical block of a VB). In various examples, the data processing and programming operations of this disclosure may be performed on a VB/VWL basis. Also or alternatively, the data processing and programming operations may be performed on a physical block/WL basis without departing from the spirit of the present disclosure.

Referring to FIG. 3B, a table 350 illustrates a first logical layout of at least a portion of the NVM media 116 of the memory device 114. The table 350 includes a plurality of columns and a plurality of rows. Headings for the columns include a plurality of channels, with each channel including a plurality of targets, and each target including a LUN and a block. Labels for the rows include a plurality of virtual page offsets. Each cell of the table 350 represents one physical block of data storage, whereas all of the cells shown in the table 350 represent one VB of data storage, which is equal to one hundred twenty eight (128) physical blocks of data storage. One row of cells in the table 350 represents a virtual page, which may correspond to a VWL.

Referring to FIG. 3C, a diagram of additional hierarchy of at least a portion of the NVM media 116 of the memory device 114 is shown. The diagram includes a plurality of blocks of data storage distributed in an array. All of the blocks in a row, which in this example includes sixteen (16) blocks, form a plane of data storage. Two (2) blocks in a column form one (1) die, and two (2) dies, DIE 0 and DIE 1, form a LUN, which may include, or be, a physical chip package that retains two (2) chips or dies. Each LUN has a respective one of a plurality of chip enable (CE) lines (CE 0 through CE 7) electrically connected to each die (DIE 0 and DIE 1), wherein each CE line receives a respective one of a plurality of CE signals. In addition, each CE line enables or disables a respective one of the LUNs. Two (2) planes and eight (8) LUNs form a respective one of a plurality of channels, CHANNEL 0 through CHANNEL 15. In the illustrated exemplary diagram of data storage, two (2) dies×two (2) planes×eight (8) LUNs×sixteen (16) channels=512 blocks of data storage, which may form a physical board, such as a printed circuit board or flexible circuit board, or a card of data storage.

Turning to FIG. 4, each of the physical memory blocks 310 includes a plurality of wordlines (WLs) 402a, 402b, 402c, . . . 402n, a plurality of bit lines (BLs) 404a, 404b, 404c, 404d. . . 404n, a plurality of cells 406, a string select line 408, string select transistors 410, a ground select line 412, ground select transistors 414, and a source line 416. In various examples, a page may be defined as a row of cells connected to the same WL (e.g., the cells 406 connected to the WL 402a are collectively referred to as a page). Each page may include a plurality of cells 406. Each cell 406 may include a transistor having a gate, a source, and a drain. Data bits may be written to the cells 406 on a page-by-page basis. Data may be erased from the plurality of cells 406 on a physical memory block basis.

Generally, each WL is an electrically conductive trace that is electrically connected to control gates of the cells in a respective row of cells. Each WL may convey an electronic signal that, according to its voltage level, selects a row (or page) of cells. (Each WL 402a, 402b, 402c, . . . 402n may be drawn as a horizontal line shown in FIG. 4.) When a specific WL is activated (e.g., when a read voltage is applied), the cells connected to that WL are selected for reading or writing. In NAND flash memory, cells are organized into a series of strings, with each string being connected to one of a plurality of BLs, wherein each BL is an electrically conductive trace that is electrically connected to the drains of cells in a column of cells. Each BL may convey an electronic signal that, according to its voltage level, may enable data transfer to and from the cells of a selected WL during read and write operations. (Each BL 404a, 404b, 404c, 404d . . . 404n may be drawn as a vertical line shown in FIG. 4.) During a read operation, the voltage on the BL reflects a state of the selected cell(s). Accordingly, the voltage and/or current of the BL may be measured and/or determined to determine the value of the data in the selected cells.

In various examples, the cells 406 may include single-level cells (SLCs), multi-level cells (MLCs), triple-level cells (TLCs), quadruple-level cells (QLCs), and/or penta-level cells (PLCs), without limitation. Accordingly, the WLs 402a, 402b, 402c, . . . 402n may be SLC wordlines, MLC wordlines, QLC wordlines and/or PLC wordlines, without limitation. In an example, a TLC wordline may include a lower page, a middle page, and an upper page. The lower page, middle page, and upper page may correspond to a page including a row of TLCs. The TLC wordline may be activated to write data to each of the upper, middle, and lower pages. Accordingly, an SLC wordline may include one (1) page, an MLC wordline may include two pages (2), a TLC wordline may include three (3) pages, a QLC wordline may include four (4) pages, and a PLC wordline may include five (5) pages.

Generally, a read voltage threshold may correspond to a reference voltage used when reading data from a cell. During a read operation, a read voltage may be applied to a WL corresponding to a page, or row of cells. In response to applying the read voltage, each cell may produce a current having a voltage value corresponding to a voltage threshold of that cell. The voltage threshold of the cells may be compared to the reference voltage to determine the value of the data in the cells. In the case of a triple-level cell (TLC), seven (7) different reference voltages are needed to read the three (3) bits stored in the TLC. Specifically, two (2) reference voltages may be used to read a first bit from the TLC, three (3) reference voltages may be used to read a second bit from the TLC, and two (2) reference voltages may be used to read a third bit from the TLC.

The string select line 408 is an electrically conductive trace that is electrically connected to the gates of the string select transistors 410. The string select line 408 may convey an electronic signal that, according to its voltage level, selects one or more of the string select transistors 410. A BL bias voltage may be supplied to one or more of the BLs 404a, 404b, 404c, 404d, . . . 404n via the string select line 408. Similarly, the ground select line 412 is an electrically conductive trace that is electrically connected to the gates of the ground select transistors 414. The ground select line 412 may convey an electronic signal that, according to its voltage level, selects one or more of the ground select transistors 414. The string select transistors 410, when activated (e.g., by receiving a BL bias voltage), may connect a string (or column) of cells 406 to a corresponding one of the bitlines 404a, 404b, 404c, 404d, . . . 404n. The ground select transistors 414, when activated, may connect a string (or column) of cells 406 to the source line 416. The source line 416 is an electrically conductive trace that is electrically connected to the sources of the cells 406. The source line 416, in turn, may connect the string of cells to a common ground (or reference) voltage. The source line 416 may be connected to a sense amplifier (not shown), which may measure a string current (Icell) and/or voltage of the activated cells 406, thereby determining a value of the data stored in the activated cells 406.

Returning to FIG. 1, the Vpassr adjustment component 112 may monitor errors produced by one or more (e.g., each) of the NVM 116 during operation of the memory device 114. If the Vpassr adjustment component 112 detects an increase in the number of errors (e.g., over a pre-determined period of time and/or between successive read operations), the Vpassr adjustment component 112 may infer a cross-temperature condition based on the detected errors and/or may read a current temperature of the data storage system 104 from the temperature sensor(s) 113 and/or the local controller(s) 118. The Vpassr adjustment component 112 may determine that the current temperature is significantly different than a normal operating temperature range of the data storage system 104. Responsive to determining that the current temperature is significantly different than the normal operating temperature range and/or an average operating temperature, the Vpassr adjustment component 112 may determine that the increase in the number of errors is likely caused by a cross-temperature condition. The increase in the number of errors may occur in a certain period of time (e.g., within a number of seconds, a number of minutes, or a number of hours), and the corresponding time lapse and/or profile over time may be indicative of or correlated with cross-temperature condition(s). If the current temperature is greater than the normal operating temperature range, the Vpassr may be decreased. If the current temperature is less than the normal operating temperature range, the Vpassr may be increased.

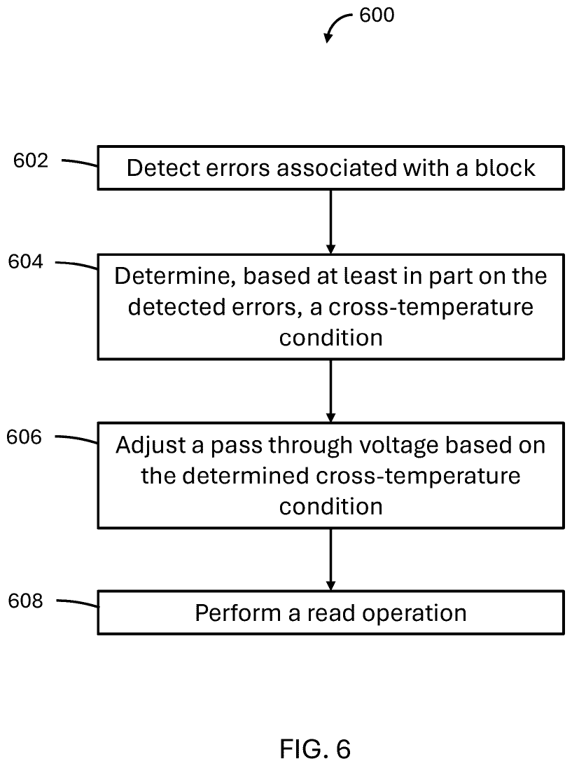

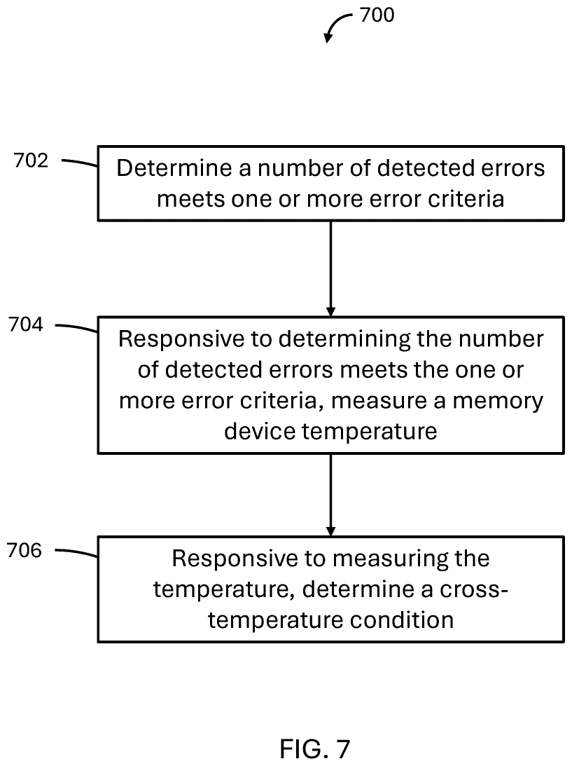

Additional operations and details associated with determining cross-temperature conditions and adjusting Vpassr are described in greater detail below in connection with the method 600 of FIG. 6 and the method 700 of FIG. 7. In various examples, the Vpassr adjustment component 112 may perform any and/or all operations described below with reference to FIGS. 6 and 7.

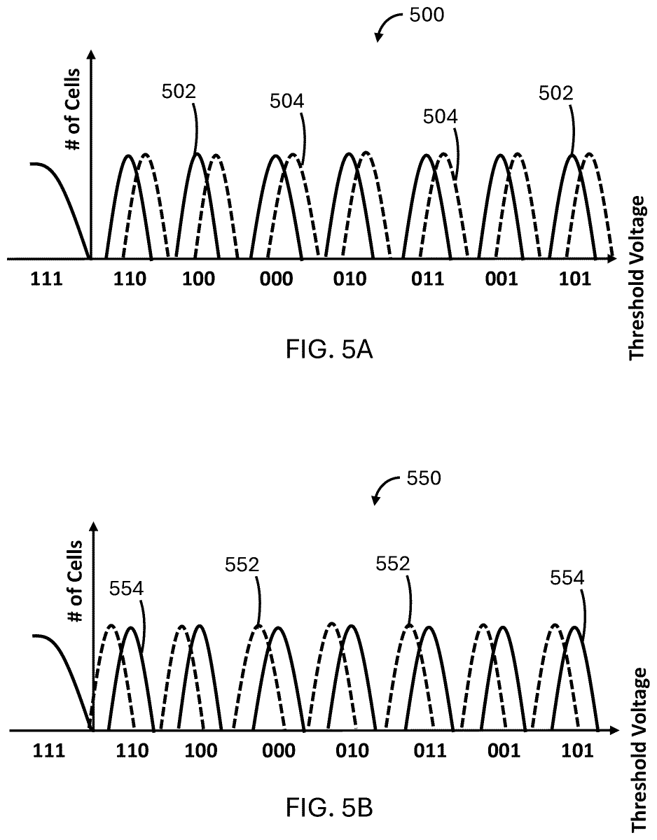

FIGS. 5A and 5B illustrate voltage thresholds corresponding to various programming states of a TLC wordline of the memory device 114 under different temperature conditions. Generally, each programming state may correspond to a read voltage threshold. Each read voltage threshold may include a range of voltage values. If a read temperature (e.g., an operating temperature of the memory device at the time of a read operation) is greater than a program temperature (e.g., the operating temperature of the memory device at the time of a program operation), the read voltage thresholds may be decreased. Inversely, if the read temperature is less than the program temperature, the read voltage thresholds may be increased. When the operating temperature increases above a typical operating temperature range, average temperature, or rated temperature, the decreased voltage thresholds may cause a significant increase in errors as the voltage thresholds fall below an expected voltage range. When the operating temperature decreases below a typical operating temperature range, average temperature, or rated temperature, the increased voltage thresholds may cause a significant increase in errors as the voltage thresholds increase above an expected voltage range.

Turning more specifically to FIG. 5A, a graph 500 of voltage thresholds is illustrated corresponding to various programming states of a TLC wordline associated with a program temperature greater than a read temperature. The voltage thresholds include voltage thresholds 502 and voltage thresholds 504. The solid line voltage thresholds 502 correspond to the voltage thresholds of the TLC wordline when data is programmed to the TLC wordline at a first temperature. The broken line voltage thresholds 504 correspond to the voltage thresholds of the TLC wordline when data is read from the TLC wordline at a second temperature. The first temperature is greater than the second temperature. The voltage thresholds of the TLC wordline may increase after programming as the temperature decreases. The increased voltage thresholds may increase a resistance of the cells in the TLC wordline, thereby causing a decrease in a string current (Icell) of the cells during a read operation.

Turning to FIG. 5B, a graph 550 of voltage thresholds is illustrated corresponding to various programming states of a TLC wordline associated with a read temperature greater than a program temperature. The voltage thresholds include voltage thresholds 552 and voltage thresholds 554. The solid line voltage thresholds 554 correspond to the voltage thresholds of the TLC wordline when data is programmed to the TLC wordline at a first temperature. The broken line voltage thresholds 552 correspond to the voltage thresholds of the TLC wordline when data is read from the TLC wordline at a second temperature. The second temperature is greater than the first temperature. The voltage thresholds of the TLC wordline may decrease after programming as the temperature increases. The decreased voltage thresholds may decrease a resistance of the cells in the TLC wordline, thereby causing Icell to increase during a read operation.

In various examples, instructions for executing the Vpassr adjustment component 112 may be stored in the local memory 110. Some or all functions of the Vpassr adjustment component 112 may be executed by the processor 108, the temperature sensor(s) 113, the local controller(s) 118, other circuitry of the controller 106 and/or the memory device 114, and/or a combination thereof.

Through hardware, software, firmware, or various combinations thereof, any of the processing elements (e.g., the controller 106 and/or local controller(s) 118 of FIG. 1 and/or the processing element 202 of FIG. 2) may—alone or in combination with other processing elements—be configured to perform the operations of examples of the present disclosure. The examples described herein in connection with the attached drawing figures are intended to describe aspects of the disclosure in sufficient detail to enable those skilled in the art to practice the disclosure. Other examples can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

FIG. 6 illustrates an example method 600 for adjusting Vpassr to compensate for cross temperature effects. The method 600 may be performed by a controller (e.g., the controller 106 and/or the Vpassr adjustment component 112 of FIG. 1) of a data storage system (e.g., the data storage system 106 of FIG. 1). The data storage system may additionally include a memory device (e.g., the memory device 114 of FIG. 1). The memory device may include a physical block (e.g., the block 310 of FIG. 4). The physical block may include a plurality of WLs (e.g., the WLs 402a, 402b, 402c, . . . 402n of FIG. 4) and a plurality of BLs (e.g., the BLs 404a, 404b, 404c, 404d, . . . 404n of FIG. 4). Each of the WLs may include a plurality of cells (e.g., the cells 406 of FIG. 4). The data storage system may be connected to a host system (e.g., the host system 102 of FIG. 1). The method 600 may be performed in connection with the method 700 described in connection with FIG. 7 within the scope of various examples.

At operation 602, errors associated with the block may be detected. The detected errors may be associated with one or more read operations and/or one or more write operations. The detected errors may be analyzed and compared to one or more error criteria (e.g., as described in connection with operation 702 of the method 700 of FIG. 7).

At operation 604, a cross-temperature condition may be determined based on the detected errors. Responsive to determining that the detected errors meet one or more error criteria, a temperature measurement of the memory device may be performed (e.g., as described in connection with operation 704 of the method 700 of FIG. 7). The cross-temperature condition may be determined based on determining that a value of the temperature measurement is significantly different than a typical operating temperature range or average operating temperature of the memory device (e.g., as described in connection with operation 706 of the method 700 of FIG. 7). Also or alternatively, the cross temperature condition may be determined based on a known and/or learned correlation between the detected errors and the cross temperature condition.

At operation 606, a pass through voltage (Vpassr) may be adjusted for one or more of the WLs of the block based on the determined cross-temperature condition. If the cross-temperature condition is associated with a program temperature being higher than a read temperature, the Vpassr may be increased to compensate for increased read voltage thresholds (e.g., as shown in FIG. 5A) associated with the cells of the block. If the cross-temperature condition is associated with a read temperature being higher than a program temperature, the Vpassr may be decreased to compensate for decreased read voltage thresholds (e.g., as shown in FIG. 5B) associated with the cells of the block.

A value of the Vpassr adjustment may be associated with estimated read voltage thresholds of the cells in the block, the number of errors, and/or the measured temperature. For example, the read voltage thresholds of the cells may be estimated based on the number of errors, type of errors, and/or the temperature measurement. The estimated read voltage threshold may be compared to previous (or default) voltage thresholds to determine a voltage threshold deviation. The Vpassr may be adjusted in proportion to the determined voltage threshold deviation. The adjusted Vpassr may adjust a string current (Icell) according to the determined read voltage threshold deviation such that the data may be accurately read. For example, a determination may be made that the read voltage thresholds have increased above the previous (or default) read voltage thresholds or decreased below the previous (or default) read voltage thresholds. The Vpassr may be adjusted according to the determination.

In various examples, Vpassr may be the same for each unselected WL, may vary for each unselected WL, or may vary according to groups of unselected WLs, based on, for example, proximity to a ground select line (e.g., the ground select line 412 of FIG. 4), a source line (e.g., the source line 416 of FIG. 4), and/or a sense amplifier. When the Vpassr is adjusted, a value of the voltage adjustment may be the same for each unselected WL, may vary for each unselected WL, or may vary according to groups of unselected WLs, based on, for example, proximity to the ground select line, the source line, and/or the sense amplifier.

At operation 608, a read operation may be performed on a selected WL of the plurality of WLs. A BL bias voltage may be applied to one or more BLs of the block. A read voltage (Vread) may be applied to the selected WL to activate the WL. The adjusted Vpassr may be applied to one or more of the remaining (unselected) WLs so that data may pass through the one or more remaining WLs. The data may pass through a selected BL.

In various examples, the adjusted Vpassr may be applied to one or more programmed unselected WLs (UWLs) and/or unprogrammed UWLs (e.g., all remaining unprogrammed UWLs of the block), in any combination. In various examples, the adjusted Vpassr may be applied to one or more of the UWLs, another adjusted Vpassr may be applied to multiple other of the UWLs, and/or another Vpassr (e.g., a default or manufacturer-defined Vpassr) will be applied to still other of the UWLs, in any combination.

FIG. 7 illustrates an example method 700 for detecting a cross-temperature condition. The method 700 may be performed by a controller (e.g., the controller 106 and/or the Vpassr adjustment component 112 of FIG. 1) of a data storage system (e.g., the data storage system 106 of FIG. 1). The data storage system may additionally include a memory device (e.g., the memory device 114 of FIG. 1). The memory device may include a physical block (e.g., the block 310 of FIG. 4). The data storage system may be connected to a host system (e.g., the host system 102 of FIG. 1). The method 700 may be performed in connection with the method 600 (e.g., in connection with operations 602 and 604) described in connection with FIG. 6 within the scope of various examples.

At operation 702, a determination is made that a number (or type) of detected errors meet one or more error criteria. The error criteria may include an increase in the number of errors and/or an increase or presence of a certain type of error (e.g., uncorrectable errors). The increase in errors may include an increased number of errors above a threshold amount. In various examples, the threshold amount of errors may be defined during manufacture of the memory device. The error criteria may additionally include an increase in a number of errors over a certain amount of time. For example, a first read operation may be performed at a first time T1 and a second read operation may be performed at a second time T2, where the time T2 is after the time T1. A relatively larger number of errors may be produced during the second read operation compared to a number of errors produced during the first read operation. In this example, the errors may meet the error criteria based on the increased number of errors at the second time T2 compared to the number of detected errors produced at the first time T1. The second time T2 may be, for example, a certain number of second, minutes, or hours, after the first time T1.

At operation 704, a temperature of the memory device may be measured in response to determining that the number (or type) of errors meet the one or more error criteria. The temperature may be measured by one or more temperature sensors of the data storage system (e.g., the temperature sensor(s) 113 and/or the local controller(s) 118 of FIG. 1). The measured temperature may include an operating temperature of the memory device at (or near) a time of the determination that the errors meet the one or more error criteria (e.g., a real-time or near-real time operating temperature).

At operation 706, a cross-temperature condition may be determined responsive to measuring the temperature. The measured temperature may be compared to a typical operating temperature range or an average operating temperature of the memory device. If the measured temperature is significantly different than the typical operating temperature range or the average operating temperature, the cross-temperature condition may be determined. The measured temperature being significantly different may include, for example a temperature difference of five (5) ° C., ten (10) ° C., fifteen (15) ° C., twenty (20) ° C., or twenty-five (25) ° C. or more, without limitation. Additionally, a determination may be made of whether a program temperature is higher than a read temperature, based on whether the measured temperature is greater than or less than the typical operating temperature range or the average operating temperature.

In various examples, the cross-temperature condition may be inferred based on the detected errors. Estimated read voltage thresholds of the cells in the block may be determined based on the detected errors and/or the measured temperature. If the estimated read voltage thresholds have increased over a previous or default read voltage threshold, the controller may determine that the program temperature is greater than the read temperature. If the estimated read voltage thresholds have decreased below a previous or default read voltage threshold, the controller may determine that the read temperature is greater than the program temperature. Accordingly, the controller may adjust the Vpassr applied to one or more wordlines during one or more read operations to compensate for the determined cross-temperature condition, including in connection with the methods 600, 700 described in more detail above.

### Feature Combinations

According to various examples of the present disclosure, a data storage system may include a memory device, a memory including instructions stored thereon, and at least one processor. The memory device may include a block and a plurality of wordlines (WLs). The memory may include instructions stored thereon that, when executed by the at least one processor, cause the at least one processor to: detect errors associated with the block; determine, based at least in part on the detected errors, a cross-temperature condition; adjust a pass through voltage (Vpassr) based on the determined cross-temperature condition; and perform a read operation at least in part by: applying a read voltage to a first WL of the plurality of WLs; and applying the adjusted Vpassr to one or more remaining WLs of the plurality of WLs.

According to various examples of the present disclosure, a computer-implemented method may include: detecting errors associated with a block; determining, based at least in part on the detected errors, a cross-temperature condition; adjusting a pass through voltage (Vpassr) based on the determined cross-temperature condition; and performing a read operation at least in part by: applying a read voltage to a first wordline (WL) of a plurality of WLs of the block; and applying the adjusted Vpassr to one or more remaining WLs of the plurality of WLs.

According to various examples of the present disclosure, non-transitory computer readable media may have instructions stored thereon that, when executed by at least one processor, cause the at least one processor to: detect errors associated with a block; determine, based at least in part on the detected errors, a cross-temperature condition; adjust a pass through voltage (Vpassr) based on the determined cross-temperature condition; and perform a read operation at least in part by: applying a read voltage to a first wordline (WL) of a plurality of WLs of the block; and applying the adjusted Vpassr to one or more remaining WLs of the plurality of WLs.

In combination with any of the previous examples, a determination of a cross-temperature condition may include: determining a number of detected errors meets one or more error criteria; responsive to determining the number of detected errors meets the one or more error criteria, measuring a temperature of a memory device; and responsive to measuring the temperature, determining the cross-temperature condition.

In combination with any of the previous examples, a determination of a cross-temperature condition may include: determining that a read threshold voltage associated with a block has increased above a previous read threshold voltage. Adjusting a Vpassr may include increasing the Vpassr.

In combination with any of the previous examples, a determination of a cross-temperature condition may include: determining that a read threshold voltage associated with a block has decreased below a previous read threshold voltage. Adjusting a Vpassr may include decreasing the Vpassr.

In combination with any of the previous examples, a block may include a BL. The BL may include a string of cells electrically connected in series. Each cell of the string of cells may include a gate. A first cell of the string of cells may be connected to a first WL. The first cell may store data.

In combination with any of the previous examples, a read operation may be performed to read data from a first cell. The read operation may include applying a BL bias voltage to a BL.

In combination with any of the previous examples, an adjusted Vpassr may adjust a string current (Icell) of a string of cells based on a determined cross-temperature condition.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A data storage system comprising:
a memory device including a block, the block including a plurality of wordlines (WLs);
non-transitory computer readable media storing instructions thereon; and
at least one processor, wherein the instructions, when executed by the at least one processor, cause
the at least one processor to:
detect errors associated with the block;
determine, based at least in part on the detected errors, a cross-temperature condition;
adjust a pass through voltage (Vpassr) based on the determined cross-temperature condition; and
perform a read operation at least in part by—
applying a read voltage to a first WL of the plurality of WLs,
applying the adjusted Vpassr to one or more remaining WLs of the plurality of WLs.

2. The data storage system of claim 1, the determination of the cross-temperature condition including:
determining a number of the detected errors meets one or more error criteria;
responsive to determining the number of detected errors meets the one or more error criteria, measuring a temperature of the memory device; and
responsive to measuring the temperature, determining the cross-temperature condition.

3. The data storage system of claim 1, the determination of the cross-temperature condition including determining that a read threshold voltage associated with the block has increased above a previous read threshold voltage, the adjusting the Vpassr including increasing the Vpassr.

4. The data storage system of claim 1, the determination of the cross-temperature condition including determining that a read threshold voltage associated with the block has decreased below a previous read threshold voltage, the adjusting the Vpassr including decreasing the Vpassr.

5. The data storage system of claim 1, the block including a bit line (BL), the BL including a string of cells electrically connected in series, each cell of the string of cells including a gate, a first cell of the string of cells being connected to the first WL, the first cell storing data.

6. The data storage system of claim 5, the read operation being performed to read the data from the first cell and the read operation including applying a BL bias voltage to the BL.

7. The data storage system of claim 5, the adjusted Vpassr to adjust a string current (Icell) of the string of cells based on the determined cross-temperature condition.

8. A computer-implemented method comprising:
detecting errors associated with a block;
determining, based at least in part on the detected errors, a cross-temperature condition;
adjusting a pass through voltage (Vpassr) based on the determined cross-temperature condition; and
performing a read operation at least in part by—
applying a read voltage to a first wordline (WL) of a plurality of WLs of the block,
applying the adjusted Vpassr to one or more remaining WLs of the plurality of WLs.

9. The computer-implemented of claim 8, the determination of the cross-temperature condition including:
determining a number of the detected errors meets one or more error criteria;
responsive to determining the number of detected errors meets the one or more error criteria, measuring a temperature of the memory device; and
responsive to measuring the temperature, determining the cross-temperature condition.

10. The computer-implemented of claim 8, the determination of the cross-temperature condition including determining that a read threshold voltage associated with the block has increased above a default read threshold voltage, the adjusting the Vpassr including increasing the Vpassr.

11. The computer-implemented of claim 8, the determination of the cross-temperature condition including determining that a read threshold voltage associated with the block has decreased below a default read threshold voltage, the adjusting the Vpassr including decreasing the Vpassr.

12. The computer-implemented of claim 8, the block including a bit line (BL), the BL including a string of cells electrically connected in series, each cell of the string of cells including a gate, the gate of a first cell of the string of cells being connected to the first WL, the first cell storing data.

13. The computer-implemented of claim 12, the read operation being performed to read the data from the first cell and the read operation including applying a BL bias voltage to the BL.

14. The computer-implemented of claim 12, the adjusted Vpassr to adjust a string current (Icell) of the string of cells based on the determined cross-temperature condition.

15. Non-transitory computer readable media having instructions stored thereon, that when executed by at least one processor, cause the at least one processor to:
detect errors associated with a block;
determine, based at least in part on the detected errors, a cross-temperature condition;
adjust a pass through voltage (Vpassr) based on the determined cross-temperature condition; and
perform a read operation at least in part by—
applying a read voltage to a first wordline (WL) of a plurality of WLs of the block,
applying the adjusted Vpassr to one or more remaining WLs of the plurality of WLs.

16. The non-transitory computer readable media of claim 15, the determination of the cross-temperature condition including:
determining a number of the detected errors meets one or more error criteria;
responsive to determining the number of detected errors meets the one or more error criteria, measuring a temperature of the memory device; and
responsive to measuring the temperature, determining the cross-temperature condition.

17. The non-transitory computer readable media of claim 15, the determination of the cross-temperature condition including determining that a read threshold voltage associated with the block has increased above a default read threshold voltage, adjusting the Vpassr including increasing the Vpassr.

18. The non-transitory computer readable media of claim 15, the determination of the cross-temperature condition including determining that a read threshold voltage associated with the block has decreased below a default read threshold voltage, adjusting the Vpassr including decreasing the Vpassr.

19. The non-transitory computer readable media of claim 15, the block including a bit line (BL), the BL including a string of cells electrically connected in series, each cell of the string of cells including a gate, the gate of a first cell of the string of cells being connected to the first WL, the first cell storing data.

20. The non-transitory computer readable media of claim 19, the read operation being performed to read the data from the first cell and the read operation including applying a BL bias voltage to the BL, the adjusted Vpassr to adjust a string current (Icell) of the string of cells based on the determined cross-temperature condition.
